(19) United States
(12) Patent Application Publication
(10) Pub. No.: US 2026/0057465 A1
(43) Pub. Date: Feb. 26, 2026

(54) GENERATIONAL WEALTH TRANSFER SIMULATION GAME

(71) Applicant: Wells Fargo Bank, N.A., San Francisco, CA (US)

(72) Inventors: Subhashini Aggarwal, Hyderabad (IN); Srivathsan Rangaprasad, Chennai (IN); Manpreet Singh, Hyderabad (IN); Balaji Vankayala, Hyderabad (IN)

(21) Appl. No.: 18/811,385

(22) Filed: Aug. 21, 2024

(51) Int. Cl. G06Q 50/18; A63F 13/825

(52) U.S. Cl. CPC G06Q 50/186; A63F 13/825

(57) ABSTRACT

Computer-implemented systems and methods for a generational wealth transfer simulation game are provided. A method includes receiving data related to a wealth transfer of a user of a group of users, and presenting, on a user interface of a device operated by at least one user of the group of users, an interactive gaming element to obtain a user input regarding the wealth transfer. The user input is received using the interactive gaming element, an entry is generated for a blockchain based on the user input and at least some of the data, the entry including an asset for distribution for at least part of the wealth transfer and a condition for asset transfer, and the entry is stored on the blockchain at a server. In response to satisfaction of the condition, the asset is automatically distributed to at least one user of the group of users.

### TECHNICAL FIELD

Embodiments described herein generally relate to computer processing systems and, for example and without limitation, to systems and methods for a generational wealth transfer simulation game.

### BACKGROUND

Intergenerational wealth transfer encounters significant challenges, including communication gaps, unclear donor intentions, tax complexities, and the need for secure and transparent processes. Traditional methods often fail to establish a robust chain for wealth transfer, leading to potential family disputes, financial uncertainties, and the inability to address the diverse needs of recipients.

### BRIEF DESCRIPTION OF THE DRAWINGS

In the drawings, which are not necessarily drawn to scale, like numerals can describe similar components in different views. Like numerals having different letter suffixes can represent different instances of similar components. Some embodiments are illustrated by way of example, and not of limitation, in the figures of the accompanying drawings, in which;

FIG. 1 illustrates a flowchart of an example method of a generational wealth transfer simulation game;

FIG. 2 illustrates an example of a system for a generational wealth transfer simulation game;

FIG. 3 illustrates an example embodiment of a computing device used by a user for a generational wealth transfer simulation game;

FIG. 4 illustrates an example embodiment of a computing device used for a generational wealth transfer simulation game;

FIG. 5A illustrates an example embodiment of a ledger including example block entries for tracking aspects of a generational wealth transfer simulation game;

FIG. 5B illustrates an example embodiment of a user interface for interacting with a block entry; and

FIG. 6 is a block diagram of a machine in the example form of a computer system within which a set of instructions can be executed, for causing the machine to perform any one or more of the methodologies discussed herein.

### DETAILED DESCRIPTION

A user or donor may want to preserve wealth among generations by using wealth transfer mechanisms and strategies to optimize future wealth, and to educate other users or potential recipients regarding these mechanisms and strategies.

The present subject matter provides a system for a generational wealth transfer simulation game. The system provides for simulating estate planning with a game using actual wealth data, and using the results of the game or simulation to establish an estate plan using a smart contract or blockchain.

In various examples, a simulation game is provided where family members play and make decisions on wealth transfer scenarios. External partners or planners may be included, in some examples. Various time frames may be used for the simulation, including real time or near real time planning. In some examples, the present subject matter incorporates elements in the game representing the needs and wants of recipients of wealth transfers to provide for better understanding of various outcomes. The system enables players to make decisions reflecting real life intentions for wealth distribution, in various examples.

In various embodiments, the present system uses blockchain for encrypted proof of concepts, ensuring transparency and security. In some examples, the results of the game are used to develop smart contracts for automatic execution based on trigger conditions or trigger events.

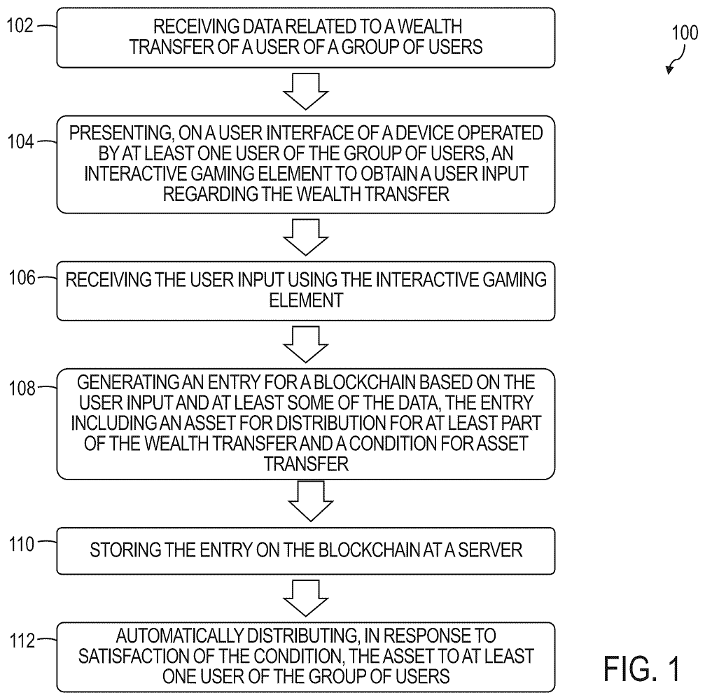

FIG. 1 illustrates a flowchart of an example method 100 of a generational wealth transfer simulation game. The computer-implemented method 100 includes receiving data related to a wealth transfer of a user of a group of users, at step 102, and presenting, on a user interface of a device operated by at least one user of the group of users, an interactive gaming element to obtain a user input regarding the wealth transfer, at step 104. At step 106, the user input is received using the interactive gaming element. At step 108, an entry is generated for a blockchain based on the user input and at least some of the data, the entry including an asset for distribution for at least part of the wealth transfer and a condition for asset transfer. The entry is stored on the blockchain at a server, at step 110. In response to satisfaction of the condition, the asset is automatically distributed to at least one user of the group of users, at step 112. In various embodiments, automatically distributing the asset refers to executing a smart contract using the blockchain entry to begin a mechanism for transferring the asset as provided by the blockchain entry. The blockchain entry may be based on a full or partial game result, in various embodiments.

According to various embodiments, the condition for asset transfer includes death of the user donor. The interactive gaming element includes a simulation of a wealth transfer scenario, in various embodiments. A plurality of gaming elements and user inputs are used, in various embodiments. In one example, the interactive gaming element includes potential decisions reflecting real life intentions for the wealth transfer. The condition for asset transfer includes incapacitation of the user, in various examples. In one example, the asset is a bank account, a retirement account, or a real estate holding. Other assets may be used without departing from the scope of the present subject matter. The automatic distribution includes a transfer outside of probate, in an example. The group of users is defined at least in part by a familial relationship, in various examples.

Various embodiments include a system for a generational wealth transfer simulation game. The system includes a computing device, the computing device comprising at least one processor and a data storage device in communication with the at least one processor, wherein the data storage device comprises instructions thereon that, when executed by the at least one processor, causes the at least one processor to execute the steps of the method of FIG. 1.

Various embodiments include a non-transitory computer-readable storage medium, the computer-readable storage medium including instructions that when executed by computers, cause the computers to perform operations of the steps of the method of FIG. 1. According to various embodiments, the condition for asset transfer includes a third party trigger condition. The third party trigger condition includes an input by a certified advisor, in an embodiment. In one embodiment, the third party trigger condition includes an alert from a health care facility or application. Other trigger conditions can be used without departing from the scope of the present subject matter.

In various examples, the present system addresses legal formalities within the game, educating users or players on the legal aspects of wealth transfer. The system may integrate a maturity evaluation system to assess understanding and decision-making skills of the players or users, in various examples. In some examples, the system may use variable wealth transfer parameters. For example, the simulation game may create a model defining parameters for wealth transfer, and adjust the amount based on specific criteria periodically. The present system may allow for flexibility in transferring chunks of wealth instead of the entire amount, in some examples.

In various examples, the present system introduces a wealth mining concept, which can generate wealth continuously for several generations. The system may also establish traceability for wealth mining, ensuring transparency and accountability. In some examples, the system may provide for family segmentation, distinguishing between core and extended family dynamics, recognizing different financial challenges. The system may provide for developing strategies to prevent the core family from falling below the poverty line using generational wealth transfers, in various examples.

The present subject matter provides many benefits. For example, the present generational wealth transfer game may reduce disputes between family members by educating them on future wealth transfers and providing simulation scenarios to guide the education process. In addition, the present system provides for adjustable parameters that may be set or changed by a donor, an advisor, or other facilitator, in various examples. The present system may assign scores based on the outcome of the game, thus increasing the confidence of users or donors and providing for future expectations. Yet another benefit of the present subject matter is the preservation of intergenerational wealth, by applying gaming scenarios that incorporate the needs of recipients that are currently living and future recipients that have not yet been born, thus ensuring the passing on of wealth based on predefined scenarios to upcoming generations.

The present system incorporates structures or scenarios for wealth mining, in various embodiments. For example, the present system may provide conditions for how wealth is mined in upcoming generations. In this example, where a current generation is deemed to be relatively wealthy, distributions may be decreased to preserve a greater share of wealth for future generations. The present simulation game may provide a proof of concept for how to keep distributions robust across generations, by generating and storing data based on real life situations, in various examples. In various embodiments, blockchains or smart contracts can use the generated data to provide for execution of wealth distributions. For example, the data may be used, in conjunction with predefined parameters available to those that currently control the wealth to be distributed, to define rules that trigger execution of the smart contracts at specific time frames or upon specific conditions.

In various embodiments, the repeated playing of the simulation game may provide for maturing of legal formalities needed to predict future outcomes. For example, the more the game is played, the more data can be used to assist players at every point in time, such that confidence increases across generations. In one example, a present playing of the game may form a rule for a future transfer, and a subsequent playing of the game may borrow some concepts from the parent game for subsequent generations, such that maturity of elements within the game can be inherited.

In some examples, the present subject matter may provide variable wealth transfer parameters that can be adjusted over time for future potential transfers, providing flexibility in the transfer of wealth. In one example a current generation may have a first wealth distribution, and a subsequent generation may have a second wealth distribution, where the first and second distributions are different. The donor may set preliminary distribution levels, thus deciding what percent of the wealth is available for recipients or players of a particular instance of the game, in various examples. The present system may incorporate donor intent, in various examples. In some examples, some donors have different intent, such as a focus on wealth preservation across generations, or a philanthropic mindset, or variability on how subsequent donors want to separate distributions, and the present system provides parameters that can be set by living donors to reflect the donor intent.

The present system uses a wealth mining concept, such as by setting pre-conditions that an entire wealth amount cannot be transferred to a first generation, and setting aside some amount for future generations, in some examples. In various examples, the present system may require a first generation to donate a certain amount to future generations, so the rules can be used to preserve wealth and protect future generations. In cases of family segmentation, the present subject matter may provide for tracing each subfamily and considering different financial situations of each subfamily, attempting to keep each subfamily from falling below an established poverty line, for example. In some examples, if core family members are not doing well financially, the present system may increase wealth transferred to the core family members.

In various examples, the donor can define ground rules for present and future instances of game play. In some scenarios, present game play may inform future gameplay by adjusting rules and using forward looking, intergenerational rules or components. In some examples, the donor decides which members of a group are provided access, and also decides or sets rules for qualifying as future group members. Based on these preset parameters and through iterations of the game, future group members may be onboarded to the game, in some examples. In various examples, donor authentication may be required while a donor is still living. In other examples, authentication can be added into the game for future group members, which may require approvals from a majority of current group members.

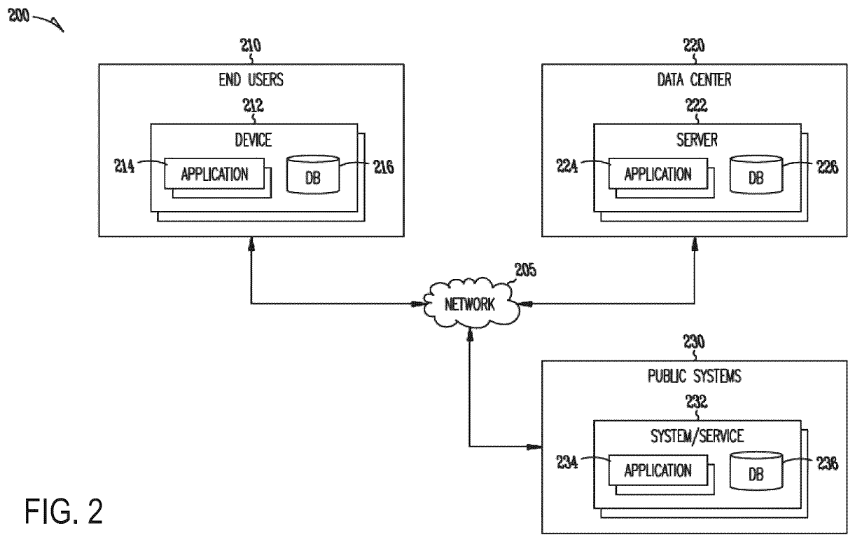

FIG. 2 illustrates an exemplary infrastructure for providing a system of the present subject matter. The infrastructure may comprise a distributed system 200 including a computing system that may include a client-server architecture or cloud computing system. Distributed system 200 may have one or more end users 210. An end user 210 may have various computing devices 212, which may be a machine 600 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

The system 200 may also include one or more data centers 220. A data center 220 may be a server 222 or the like associated with an entity that an end user 210 may interact with. The server 222 or other portions of the distributed system may create and manage the system for a generational wealth transfer simulation game, such as by performing operations including the method of FIG. 1, in various embodiments. The entity may be a computer service provider, as may be the case for a cloud services provider, or it may be a consumer product or service provider, such as a financial institution. The data center 220 may comprise one or more applications 224 and databases 226 that are designed to interface with the applications 214 and databases or data store 216 of end-user devices 212. Data centers 220 may represent facilities in different geographic locations where the servers 222 may be located. Each of the servers 222 may be in the form of a machine(s) 600.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 600.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

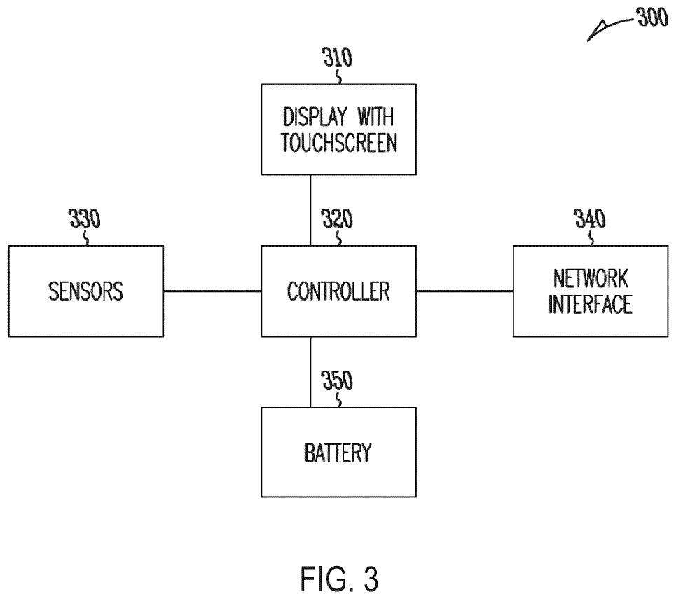

FIG. 3 illustrates an embodiment of computing device 300 used by a user for a generational wealth transfer simulation game. In the depicted embodiment, the computing device 300 includes a display with a touchscreen 310 interfaced with a controller or processor 320. The controller or processor 320 is electrically connected to one or more sensors 330, a network interface 340, and a battery 350 to supply power to the computing device 300, in various embodiments.

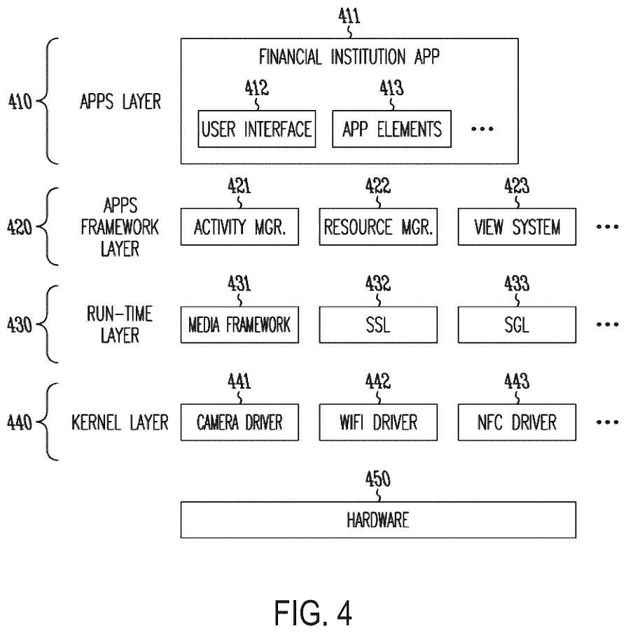

FIG. 4 illustrates an embodiment of a computing device 400 with a financial institution application 411. In various embodiments, the computing device 400 includes a mobile computing device such as a cellular telephone or smart phone. The depicted embodiment illustrates one example of software architecture executed on hardware 450, including one or more processors of the computing device 400. FIG. 4 is merely a non-limiting example of a software architecture, and many other architectures can be implemented to facilitate the functionality described herein.

The representative hardware 450 comprises one or more processing units having associated executable instructions. Executable instructions represent the executable instructions of the software architecture, including implementation of the methods, modules, and components of the present subject matter. Hardware 450 also includes memory and/or storage modules, which also have executable instructions.

In the example architecture of FIG. 4, the software can be conceptualized as a stack of layers where each layer provides particular functionality. For example, the software can include layers such as an operating system, libraries, frameworks/middleware, applications and presentation layer. Other software architectures can include additional or different layers. The operating system can manage hardware resources and provide common services. The overall system can include, for example, a kernel layer 440, run-time layer 430, application framework layer 420 and application layer 410. The kernel layer 440 can act as an abstraction layer between the hardware and the other software layers. For example, the kernel layer 440 can be responsible for memory management, processor management (e.g., scheduling), component management, networking, security settings, and so on. The drivers can be responsible for controlling or interfacing with the underlying hardware. For instance, the drivers can include display drivers, camera drivers 441, Bluetooth® drivers, flash memory drivers, serial communication drivers (e.g., Universal Serial Bus (USB) drivers), Wi-Fi® drivers 442, near field communication (NFC) drivers 443, audio drivers, power management drivers, and so forth depending on the hardware configuration.

The run-time layer 430 can include a media framework 431, a secure sockets layer (SSL) 432 and a secure group layer (SGL) 433, in various embodiments. The application framework layer 420 can include an activity manager 421, a resource manager 422, and a view system application 423, in various embodiments. The application layer 410 can include built-in applications and/or third party applications. Examples of representative built-in applications can include, but are not limited to, a contacts application, a browser application, a book reader application, a location application, a media application, a messaging application, and/or a game application. Third party applications can include any of the built in applications as well as a broad assortment of other applications. In a specific example, the third party application (e.g., an application developed using the Android™ or iOS™ software development kit (SDK) by an entity other than the vendor of the particular platform) can be mobile software running on a mobile operating system such as iOS™, Android™, Windows® Phone, or other mobile operating systems. In this example, the third party application can invoke application programming interface (API) calls provided by the operating system to facilitate functionality described herein. A financial institution application 411 can implement the functionality of a generational wealth transfer simulation game, in one embodiment. The generational wealth transfer simulation game application can be a built-in or third party application, and can include a user interface 412 and application elements 413 in various embodiments.

The applications in application layer 410 can utilize built in operating system functions (e.g., kernel, services and/or drivers), libraries, frameworks and middleware to create user interfaces to interact with users of the system. Alternatively, or additionally, in some systems interactions with a user can occur through a presentation layer. In these systems, the application/module “logic” can be separated from the aspects of the application/module that interact with a user.

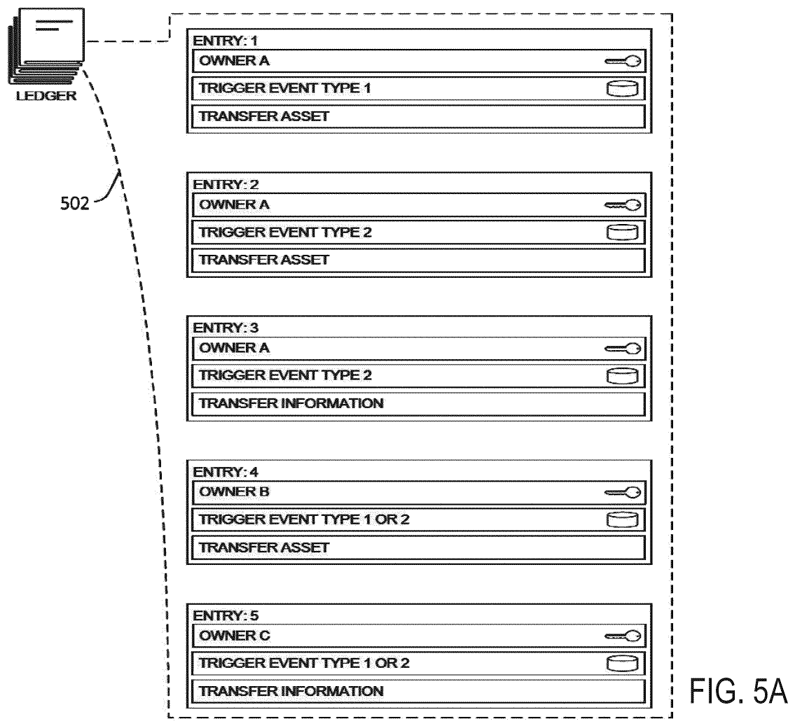

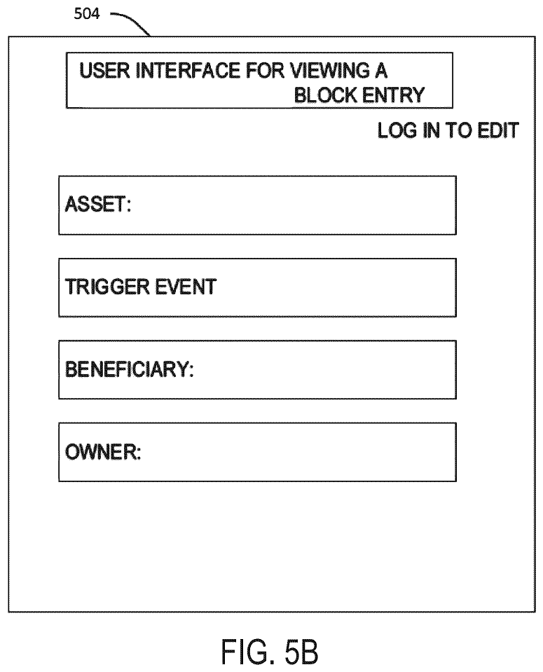

FIG. 5A illustrates an example embodiment of a ledger 502 including example block entries for tracking aspects of a generational wealth transfer simulation game. The ledger 502 includes a plurality of blocks, which may be used to store one or more entries. In some examples, the ledger 502 may correspond to a single user. In other examples, the ledger 502 may correspond to a group of users (e.g., all users of a financial institution, a group of people such as a family, etc.). In the example shown in FIG. 5A, the ledger 502 includes three owners A, B, and C, which may represent a family.

Each block in the ledger 502 may correspond to a transaction (a data creation event), an entity (e.g., a person, a company, a group of users, etc.), or an asset (e.g., a bank account, real estate, a stock account such as a 401k, a password, a location of a physical asset, etc.). The ledger 502 includes example blocks, such as entry 1 having owner A, trigger event type 1, and an indication of an action to be taken in response to the trigger event—transfer an asset. The trigger event type may be identified across the ledger 502, or may be specified within each entry. Other entries in the ledge 502 include a second trigger event type (e.g., incapacitation or death of a user), and entries 4 and 5 include both types (e.g., either trigger event occurring will trigger the transfer). Entries 3 and 5 include transfer of information instead of an asset. In an example entry, both an asset and information may be transferred. Each entry in the ledger 502 may include a block entry based on a generational wealth transfer simulation game.

An encryption scheme may be used with the ledger 502 to cryptographically sign or encrypt a block to keep the information in the block secure, and only accessible by intended parties. An example encryption includes Public Key Infrastructure (PKI), which may be implemented using an open-source certificate authority or certification authority, such as OpenCA from OpenCA PKI Research Labs. When two parties communicate using public-key encryption, the sender uses the public key belonging to the recipient and uses it to encrypt the information. On receipt of the encrypted data, the recipient uses a private key to decrypt, and thereby access the information.

In another example, the ledger 502 may be distributed (but still optionally stored using encryption, such as by hashing), and the distribution (e.g., using a blockchain with voting) may prevent changes to the ledger 502. The blocks may be stored and voted on in an encrypted format, such that they are not accessible (except to an authorized auditor or other party holding decryption keys). In an example, signing a block may revoke write access to a database, while read access is permitted. An attempt to edit a signed block may not be possible or may result in the voting identifying an unauthorized change. For example, other voters may reject a changed block as not ‘truth’ within the blockchain, and not allow the change to proceed. A timing mechanism may be used to allow changes to a signed block by the signing entity within a particular time frame (e.g., within a few minutes, an hour, a day, a week, etc.), but prevent changes after that time frame.

The ledger 502 may store blocks with encrypted information such that the information is inaccessible to anyone except the owner of the entry. In some examples, the ledger 502 may be stored privately (e.g., on a secure server or set of servers of an entity, such as a bank). In other examples, the ledger 502 may be distributed (e.g., when entries are encrypted).

FIG. 5B illustrates an example embodiment of a user interface for interacting with a block entry. The user interface 504 may be used to view a block entry, such as with previously entered details resulting from the results of game play. In some examples, the user interface 504 may be used to edit the block entry (e.g., when a user is logged in). In other examples, the block entry may not be modified by user edits, although the block entry may be edited via transfer, triggering the trigger event, or the like. The user interface 504 includes block contents such as, for example, asset type, trigger event, beneficiary, and current owner. The user interface 504 may shows additional information about the asset, which may be hidden or encrypted. The user interface 504 may also show a block number for the block entry, as well as a chain identifier (e.g., where the block entry is stored), in various examples.

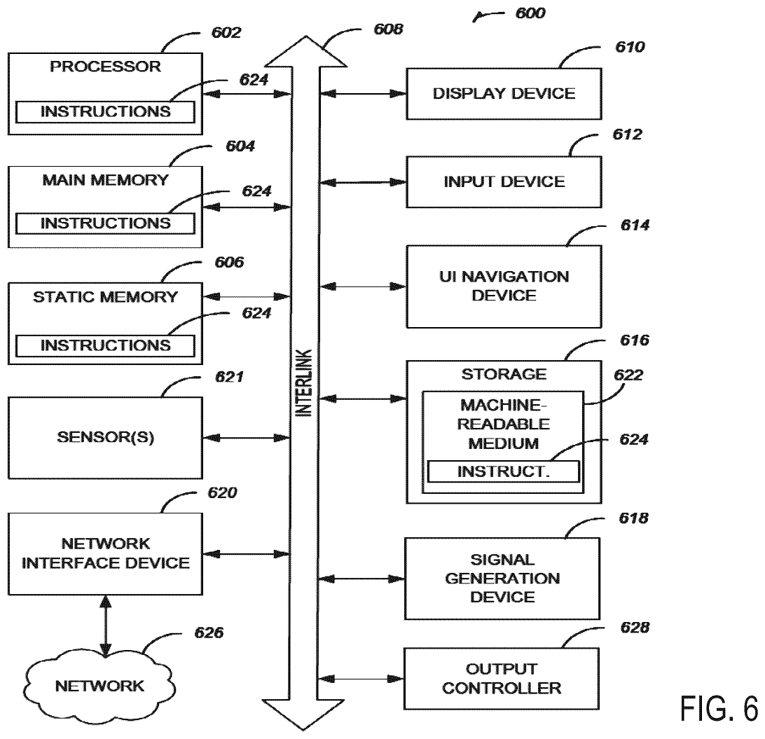

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a computer-implemented method comprising: receiving, by a processor, data related to a wealth transfer of a user of a group of users; presenting, by the processor on a user interface of a device operated by at least one user of the group of users, an interactive gaming element to obtain a user input regarding the wealth transfer; receiving, by the processor, the user input using the interactive gaming element; generating, by the processor, an entry for a blockchain based on the user input and at least some of the data, the entry including an asset for distribution for at least part of the wealth transfer and a condition for asset transfer; storing, by the processor, the entry on the blockchain at a server; and automatically distributing by the processor, in response to satisfaction of the condition, the asset to the at least one user of the group of users.

In Example 2, the subject matter of Example 1 includes, wherein the condition for asset transfer includes death of the user.

In Example 3, the subject matter of Examples 1-2 includes, wherein the interactive gaming element includes a simulation of a wealth transfer scenario.

In Example 4, the subject matter of Examples 1-3 includes, wherein the interactive gaming element includes potential decisions reflecting real life intentions for the wealth transfer.

In Example 5, the subject matter of Examples 1-4 includes, wherein the condition for asset transfer includes incapacitation of the user.

In Example 6, the subject matter of Examples 1-5 includes, wherein the asset is a bank account, a retirement account, or a real estate holding.

In Example 7, the subject matter of Examples 1-6 includes, wherein the automatic distribution includes a transfer outside of probate.

In Example 8, the subject matter of Examples 1-7 includes, wherein the group of users is defined at least in part by a familial relationship.

Example 9 is a system comprising a computing device comprising at least one processor and a data storage device in communication with the at least one processor, wherein the data storage device comprises instructions thereon that, when executed by the at least one processor, causes the at least one processor to: receive data related to a wealth transfer of a user of a group of users; present, on a user interface of a device operated by at least one user of the group of users, an interactive gaming element to obtain a user input regarding the wealth transfer; receive the user input using the interactive gaming element; generate an entry for a blockchain based on the user input and at least some of the data, the entry including an asset for distribution for at least part of the wealth transfer and a condition for asset transfer; store the entry on the blockchain at a server; and automatically distribute, in response to satisfaction of the condition, the asset to the at least one user of the group of users.

In Example 10, the subject matter of Example 9 includes, wherein the condition for asset transfer includes death of the user.

In Example 11, the subject matter of Examples 9-10 includes, wherein the interactive gaming element includes a simulation of a wealth transfer scenario.

In Example 12, the subject matter of Examples 9-11 includes, wherein the interactive gaming element includes potential decisions reflecting real life intentions for the wealth transfer.

In Example 13, the subject matter of Examples 9-12 includes, wherein the condition for asset transfer includes incapacitation of the user.

In Example 14, the subject matter of Examples 9-13 includes, wherein the asset is a bank account, a retirement account, or a real estate holding.

In Example 15, the subject matter of Examples 9-14 includes, wherein the automatic distribution includes a transfer outside of probate.

In Example 16, the subject matter of Examples 9-15 includes, wherein the group of users is defined at least in part by a familial relationship.

Example 17 is a non-transitory computer-readable storage medium, the non-transitory computer-readable storage medium including instructions that when executed by computers, cause the computers to perform operations of: receiving data related to a wealth transfer of a user of a group of users; presenting, on a user interface of a device operated by at least one user of the group of users, an interactive gaming element to obtain a user input regarding the wealth transfer; receiving the user input using the interactive gaming element; generating an entry for a blockchain based on the user input and at least some of the data, the entry including an asset for distribution for at least part of the wealth transfer and a condition for asset transfer; storing the entry on the blockchain at a server; and automatically distributing, in response to satisfaction of the condition, the asset to the at least one user of the group of users.

In Example 18, the subject matter of Example 17 includes, wherein the condition for asset transfer includes a third party trigger condition.

In Example 19, the subject matter of Example 18 includes, wherein the third party trigger condition includes an input by a certified advisor.

In Example 20, the subject matter of Example 18 includes, wherein the third party trigger condition includes an alert from a health care facility or application.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F. R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
receiving, by a processor, data related to a wealth transfer of a donor user of a group of users;
presenting, by the processor on a user interface of a device operated by at least one recipient user of the group of users, an interactive gaming element to obtain a user input regarding the wealth transfer, the interactive gaming element comprising a simulation of wealth transfer scenarios with configurable parameters that reflect real life intentions for the wealth transfer, wherein the interactive gaming element includes potential decisions for the donor user that affect distribution outcomes based on predefined gaming rules;
receiving, by the processor, the user input using the interactive gaming element;
generating, by the processor, an entry for a blockchain based on the user input and at least some of the data, the entry including an asset for distribution for at least part of the wealth transfer and a condition for asset transfer;
storing, by the processor, the entry on the blockchain at a server; and
automatically distributing by the processor, in response to satisfaction of the condition, the asset to the at least one recipient user of the group of users, wherein the automatic distribution comprises executing a smart contract based on the blockchain entry to initiate transfer of the asset outside of probate.

2. The computer-implemented method of claim 1, wherein the condition for asset transfer includes death of the user.

3. The computer-implemented method of claim 1, wherein the interactive gaming element includes a simulation of a wealth transfer scenario.

4. The computer-implemented method of claim 1, wherein the interactive gaming element includes potential decisions reflecting real life intentions for the wealth transfer.

5. The computer-implemented method of claim 1, wherein the condition for asset transfer includes incapacitation of the user.

6. The computer-implemented method of claim 1, wherein the asset is a bank account, a retirement account, or a real estate holding.

7. The computer-implemented method of claim 1, wherein the automatic distribution includes a transfer outside of probate.

8. The computer-implemented method of claim 1, wherein the group of users is defined at least in part by a familial relationship.

9. A system comprising:
a computing device comprising at least one processor and a data storage device in communication with the at least one processor, wherein the data storage device comprises instructions thereon that, when executed by the at least one processor, causes the at least one processor to:
receive data related to a wealth transfer of a donor user of a group of users;
present, on a user interface of a device operated by at least one recipient user of the group of users, an interactive gaming element to obtain a user input regarding the wealth transfer, the interactive gaming element comprising a simulation of wealth transfer scenarios with configurable parameters that reflect real life intentions for the wealth transfer, wherein the interactive gaming element includes potential decisions for the donor user that affect distribution outcomes based on predefined gaming rules;
receive the user input using the interactive gaming element;
generate an entry for a blockchain based on the user input and at least some of the data, the entry including an asset for distribution for at least part of the wealth transfer and a condition for asset transfer;
store the entry on the blockchain at a server; and
automatically distribute, in response to satisfaction of the condition, the asset to the at least one recipient user of the group of users, wherein the automatic distribution comprises executing a smart contract based on the blockchain entry to initiate transfer of the asset outside of probate.

10. The system of claim 9, wherein the condition for asset transfer includes death of the user.

11. The system of claim 9, wherein the interactive gaming element includes a simulation of a wealth transfer scenario.

12. The system of claim 9, wherein the interactive gaming element includes potential decisions reflecting real life intentions for the wealth transfer.

13. The system of claim 9, wherein the condition for asset transfer includes incapacitation of the user.

14. The system of claim 9, wherein the asset is a bank account, a retirement account, or a real estate holding.

15. The system of claim 9, wherein the automatic distribution includes a transfer outside of probate.

16. The system of claim 9, wherein the group of users is defined at least in part by a familial relationship.

17. A non-transitory computer-readable storage medium, the non-transitory computer-readable storage medium including instructions that when executed by computers, cause the computers to perform operations of:
receiving data related to a wealth transfer of a donor user of a group of users;
presenting, on a user interface of a device operated by at least one recipient user of the group of users, an interactive gaming element to obtain a user input regarding the wealth transfer, the interactive gaming element comprising a simulation of wealth transfer scenarios with configurable parameters that reflect real life intentions for the wealth transfer, wherein the interactive gaming element includes potential decisions for the donor user that affect distribution outcomes based on predefined gaming rules;
receiving the user input using the interactive gaming element;
generating an entry for a blockchain based on the user input and at least some of the data, the entry including an asset for distribution for at least part of the wealth transfer and a condition for asset transfer;
storing the entry on the blockchain at a server; and
automatically distributing, in response to satisfaction of the condition, the asset to the at least one recipient user of the group of users, wherein the automatic distribution comprises executing a smart contract based on the blockchain entry to initiate transfer of the asset outside of probate.

18. The non-transitory computer-readable storage medium of claim 17, wherein the condition for asset transfer includes a third party trigger condition.

19. The non-transitory computer-readable storage medium of claim 18, wherein the third party trigger condition includes an input by a certified advisor.

20. The non-transitory computer-readable storage medium of claim 18, wherein the third party trigger condition includes an alert from a health care facility or application.
